(19) United States
(12) Patent Application Publication
(10) Pub. No.: US 2026/0001543 A1
(43) Pub. Date: Jan. 1, 2026

(54) DRIVING CONTROL DEVICE, DRIVING CONTROL METHOD, AND DRIVING CONTROL PROGRAM

(71) Applicants: TOYOTA JIDOSHA KABUSHIKI KAISHA, Aichi-ken (JP); DENSO CORPORATION, Aichi-pref (JP)

(72) Inventors: Shunta SANO, Susono-shi (JP); Masakazu NISHIJIMA, Ebina-shi (JP)

(21) Appl. No.: 19/238,527

(22) Filed: Jun. 16, 2025

(30) Foreign Application Priority Data
Jun. 26, 2024 (JP) 2024-103013

(51) Int. Cl. B60W 30/16; B60W 10/18; B60W 10/20

(52) U.S. Cl. CPC B60W 30/16; B60W 10/20; B60W 10/18; B60W 2554/4041

(57) ABSTRACT

A driving control device that controls driving of a vehicle includes a driving control unit configured to, when a specific object is located in a steering operation region set in front of the vehicle, execute separation steering control of performing steering to maintain a distance between the vehicle and the object, and when the specific object is located in a deceleration operation region set in front of the vehicle, execute deceleration control of decelerating the vehicle. In a case where an object is entering or is about to enter a travel path of the vehicle during the execution of the separation steering control, the driving control unit changes an execution mode of the separation steering control or the deceleration control to cause a collision risk with the object to be reduced, compared to any other case.

### TECHNICAL FIELD

The present disclosure relates to a driving control device, a driving control method, and a driving control program.

### BACKGROUND

In related art, a driving control device is known that performs steering, braking, and the like of a vehicle, in order to avoid a collision between an object and the vehicle, when the object, such as a pedestrian, is present in front of the vehicle (JP 2019-028951 A, JP 2015-155295 A, and the like). In particular, JP 2019-028951 A discloses that when a moving object is located within a prescribed area created with reference to a stationary object existing in front of a vehicle, driving assistance is performed to reduce a possibility of collision between the moving object and the vehicle.

### SUMMARY

However, even with the devices described in JP 2019-028951 A and JP 2015-155295 A, there is room for improvement in reducing the possibility of collision between the vehicle and an object, such as a pedestrian who is entering a travel path of the vehicle, or a pedestrian who is about to enter the travel path of the vehicle.

In view of the above problem, it is an object of the present disclosure to reduce a possibility of a collision between a vehicle and a specific object that is entering or is about to enter a travel path of the vehicle.

The gist of the present disclosure is as follows.
(1) A driving control device that controls driving of a vehicle, the driving control device comprising:
a driving control unit configured to, when a specific object is located in a steering operation region set in front of the vehicle, execute separation steering control of performing steering to maintain a distance between the vehicle and the object, and when the specific object is located in a deceleration operation region set in front of the vehicle, execute deceleration control of decelerating the vehicle, wherein
in a case where an object is entering or is about to enter a travel path of the vehicle during the execution of the separation steering control, the driving control unit changes an execution mode of the separation steering control or the deceleration control to cause a collision risk with the object to be reduced, compared to any other case.
(2) The driving control device according to above (1), wherein
in the separation steering control, the driving control unit performs steering to maintain the distance between the vehicle and the object based on a current position of the object, and
in a case where the object is entering or is about to enter the travel path of the vehicle during the execution of the separation steering control and it is predicted that the object will interfere with the vehicle when the vehicle is controlled by the separation steering control, the driving control unit does not execute the separation steering control.
(3) The driving control device according to above (1) or (2), further comprising:
an object trajectory estimation unit configured to estimate a predicted movement trajectory of the object; and
a vehicle trajectory estimation unit configured to estimate a scheduled movement trajectory of the vehicle in a case where the separation steering control is executed and in a case where the separation steering control is not executed, wherein
in a case where the object is entering or is about to enter the travel path of the vehicle during the execution of the separation steering control and a shortest distance between the object passing along the predicted movement trajectory and the vehicle passing along the scheduled movement trajectory in a case where the separation steering control is executed is shorter than a shortest distance between the object passing along the predicted movement trajectory and the vehicle passing along the scheduled movement trajectory in a case where the separation steering control is not executed, the separation steering control is not executed.
(4) The driving control device according to above (3), wherein
in a case where the object is entering or is about to enter the travel path of the vehicle during the execution of the separation steering control and the shortest distance between the object passing along the predicted movement trajectory and the vehicle passing along the scheduled movement trajectory in a case where the separation steering control is executed is longer than the shortest distance between the object passing along the predicted movement trajectory and the vehicle passing along the scheduled movement trajectory in a case where the separation steering control is not executed, the separation steering control is executed.
(5) The driving control device according to any one of above (1)-(4), wherein
in a case where the object enters into the travel path of the vehicle during the execution of the separation steering control, the driving control unit causes a start timing of the deceleration control to be earlier compared to a case where the object enters into the travel path of the vehicle when the separation steering control is not being executed.
(6) The driving control device according to above (5), further comprising:
an object detection unit configured to detect an object in front of the vehicle, wherein
in a case where the separation steering control is not being executed, the driving control unit executes the deceleration control when it is continuously detected, over a certain period of time, that the object is located in the deceleration operation region, and does not execute the deceleration control before the certain time period elapses, and
in a case where the separation steering control is being executed, the driving control unit executes the deceleration control as soon as it is detected that the object is located in the deceleration operation region.
(7) The driving control device according to above (6), wherein
in a case where the separation steering control is being executed, the driving control unit executes the deceleration control as soon as it is detected that an object recognized as being located in the steering operation region different from the deceleration operation region is located in the deceleration operation region, and
in a case where, even when the separation steering control is being executed, it is detected that an object different from the object recognized as being located in the steering operation region is located in the deceleration operation region, the driving control unit executes the deceleration control when it is continuously detected, over a certain period of time, that the object is located in the deceleration operation region.
(8) The driving control device according to any one of above (1)-(7), wherein
the steering operation region and the deceleration operation region are different regions,
the steering operation region includes a region in front of and to the side of the vehicle, and
the deceleration operation region includes a region centrally in front of the vehicle.
(9) A driving control method of controlling driving of a vehicle, the method comprising:
when a specific object is located in a steering operation region set in front of the vehicle, executing separation steering control of performing steering to maintain a distance between the vehicle and the object, and, when the specific object is located in a deceleration operation region set in front of the vehicle, executing deceleration control of decelerating the vehicle; and
in a case where an object is entering or is about to enter a travel path of the vehicle during execution of the separation steering control, changing an execution mode of the separation steering control or the deceleration control to cause a collision risk with the object to be reduced, compared to any other case.
(10) A driving control program of controlling driving of a vehicle, the driving control program causing a computer to execute processes comprising:
when a specific object is located in a steering operation region set in front of the vehicle, executing separation steering control of performing steering to maintain a distance between the vehicle and the object, and, when the specific object is located in a deceleration operation region set in front of the vehicle, executing deceleration control of decelerating the vehicle; and
in a case where an object is entering or is about to enter a travel path of the vehicle during execution of the separation steering control, changing an execution mode of the separation steering control or the deceleration control to cause a collision risk with the object to be reduced, compared to any other case.

### BRIEF DESCRIPTION OF DRAWINGS

FIG. 1 is a configuration diagram schematically illustrating a driving control system to which is mounted a driving control device according to an embodiment.

FIG. 2 is a functional block diagram of a processor of an ECU.

FIG. 3 is a diagram schematically illustrating a state in which separation steering control is performed.

FIG. 4 is a diagram schematically illustrating a state in which deceleration control is performed.

FIG. 5 is a diagram similar to FIG. 3, illustrating a state in which the separation steering control is performed.

FIG. 6 is a diagram similar to FIG. 4, illustrating a state in which the deceleration control is performed.

FIG. 7 is a diagram similar to FIGS. 3 and 5, illustrating a state in which the separation steering control is performed.

FIG. 8 is a diagram similar to FIG. 4, illustrating a state in which the deceleration control is performed.

FIG. 9 is a flowchart illustrating a flow of separation steering processing to determine whether or not execution of the separation steering control is necessary.

FIG. 10 is a flowchart illustrating a flow of deceleration processing to determine whether or not execution of the deceleration control is necessary.

### DESCRIPTION OF EMBODIMENTS

Hereinafter, embodiments will be described in detail with reference to the drawings. In the following description, similar components are denoted by the same reference numerals.

### Configuration of Driving Control System

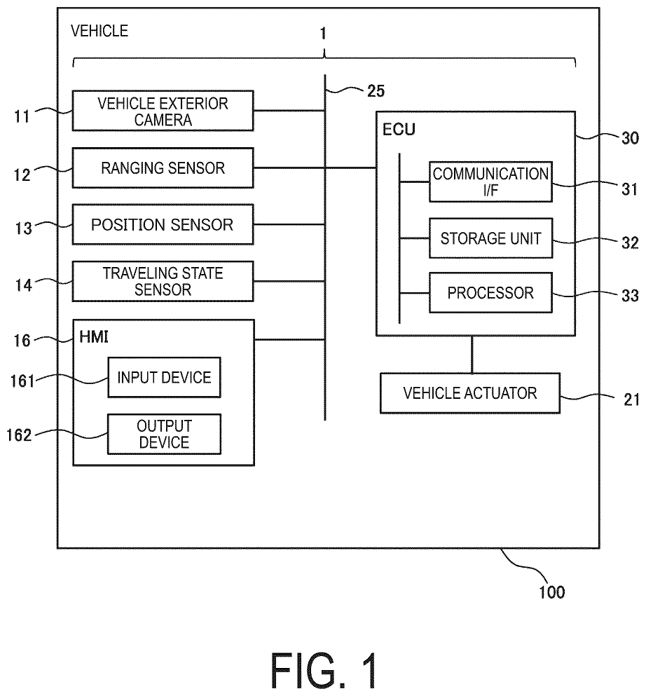

FIG. 1 is a configuration diagram schematically illustrating a driving control system 1 to which is mounted a driving control device according to an embodiment. The driving control system 1 is installed in a vehicle 100 and executes steering control to steer the vehicle 100 and deceleration control to decelerate the vehicle 100. In the present embodiment, the driving control system 1 includes a vehicle exterior camera 11, a ranging sensor 12, a position sensor 13, a traveling state sensor 14, a human machine interface (hereinafter referred to as an “HMI”) 16, a vehicle actuator 21, and an electronic control unit (hereinafter referred to as an “ECU”) 30.

However, the driving control system 1 need not necessarily include all of these. For example, the vehicle 100 need not necessarily include the ranging sensor 12, as long as the vehicle 100 includes the vehicle exterior camera 11.

The vehicle exterior camera 11, the ranging sensor 12, the position sensor 13, the traveling state sensor 14, the HMI 16, and the ECU 30 are communicably connected to each other via an in-vehicle network 25. The in-vehicle network 25 is a network conforming to a standard such as a controller area network (CAN). Further, the ECU 30 is connected to a vehicle actuator 21 via a signal line. The ECU 30 may be connected to the vehicle actuator 21 via the in-vehicle network 25, and may be connected to the ranging sensor 12, the position sensor 13, the traveling state sensor 14, or the HMI 16 via signal lines.

The vehicle exterior camera 11 is an example of a peripheral sensor that generates peripheral data representing a state around the vehicle. The vehicle exterior camera 11 captures an image of a surrounding area of the vehicle 100, and in the present embodiment, captures an image to the front of the vehicle 100. The vehicle exterior camera 11 is a CMOS camera or a CCD camera having sensitivity to visible light. The vehicle exterior camera 11 captures an image of a front region to the front of the vehicle 100 at a predetermined image capture interval, and generates image data of the captured front region. Each time the image data is generated, the vehicle exterior camera 11 outputs the generated image data to the ECU 30 via the in-vehicle network 25. Note that the vehicle exterior camera 11 may be a monocular camera or may be a stereo camera. In a case where the stereo camera is used as the vehicle exterior camera 11, the vehicle exterior camera 11 also functions as the ranging sensor 12. The vehicle 100 may be provided with a plurality of vehicle exterior cameras having different image capture directions or focal distances.

The ranging sensor 12 is an example of a peripheral sensor that generates peripheral data representing the state around the vehicle. The ranging sensor 12 measures a distance to an object present in the surrounding area of the vehicle 100, and, in the present embodiment, measures a distance to an object present in front of the vehicle 100. Further, the ranging sensor 12 can also measure the azimuth and a relative speed of the object present in the surrounding (in front) of the vehicle 100. The ranging sensor 12 is, for example, a radar such as a millimeter-wave radar, a LiDAR, or a sonar. The ranging sensor 12 outputs measurement data of the distance to the surrounding object, to the ECU 30 via the in-vehicle network 25, at a predetermined interval.

The position sensor 13 is an example of a vehicle sensor that generates vehicle data representing a state of the vehicle. The position sensor 13 measures an own position of the vehicle 100. The position sensor 13 is, for example, a GNSS receiver. The GNSS receiver receives GNSS signals from a plurality of GNSS satellites and measures the own position of the vehicle 100 based on the received GNSS signals. The position sensor 13 generates own position data representing the own position of the vehicle 100 at a predetermined interval, and outputs the own position data to the ECU 30 via the in-vehicle network 25. The position sensor 13 may be a receiver conforming to another satellite positioning system as long as the position sensor 13 can measure the own position of the vehicle 100.

The traveling state sensor 14 is an example of a vehicle sensor that generates vehicle data representing the state of the vehicle. The traveling state sensor 14 detects a traveling state of the vehicle 100. The traveling state sensor 14 detects, for example, a speed of the vehicle 100, an acceleration of the vehicle 100, a change rate (yaw rate) of a yaw angle at a time of turning of the vehicle 100, and the like. The traveling state sensor 14 outputs detection data of the traveling state to the ECU 30 via the in-vehicle network 25.

The HMI 16 is a user interface for exchanging information between the ECU 30 of the vehicle 100 and an occupant of the vehicle 100. The HMI 16 includes an input device 161 that receives an input from the occupant of the vehicle 100, and an output device 162 that performs notification to the occupant of the vehicle 100. The input device 161 is a device that receives a physical operation or a voice operation by the occupant as an input, and includes, for example, at least one of a touch panel, a switch, a button, a microphone, and the like. On the other hand, the output device 162 is a device that performs the notification to the occupant through five senses (for example, visual sense, auditory sense, tactile sense, and the like) of the occupant, and includes, for example, at least one of a display device (a liquid crystal display, a head-up display, a warning lamp, and the like, for example), a speaker, a vibration unit, and the like.

The HMI 16 transmits the input data received from the occupant via the input device 161 to the ECU 30 via the in-vehicle network 25. Further, via the output device 162, the HMI 16 notifies the occupant of information corresponding to a signal received from the ECU 30 via the in-vehicle network 25.

The vehicle actuator 21 is an actuator used to control the driving of the vehicle 100. Specifically, for example, the vehicle actuator 21 includes a drive actuator that controls an internal combustion engine or an electric motor for driving the vehicle 100, a braking actuator that controls a brake that brakes the vehicle 100, and a steering actuator that controls steering of the vehicle 100. The vehicle actuator 21 controls the acceleration, braking, and steering of the vehicle 100 in accordance with control signals transmitted via signal lines from the ECU 30.

### Outline of Driving Control Device

The ECU 30 functions as a driving control device that controls the driving of the vehicle 100. In the present embodiment, the ECU 30 executes steering control for steering the vehicle 100 and deceleration control for decelerating the vehicle 100, based on data transmitted from the vehicle exterior camera 11 and the ranging sensor 12. In the example illustrated in FIG. 1, the driving control system 1 includes the single ECU 30, but may include a plurality of the ECUs 30 divided for each of the functions. The ECU 30 includes a communication interface 31, a storage unit 32, and a processor 33. The communication interface 31, the storage unit 32, and the processor 33 may be separate circuits or may be configured as a single integrated circuit.

The communication interface 31 includes a communication interface circuit and a device interface circuit. The communication interface circuit is a circuit for connecting the ECU 30 to the in-vehicle network 25. The device interface circuit is a circuit for outputting a control signal to the vehicle actuator 21. The communication interface 31 transmits signals received from the vehicle exterior camera 11, the ranging sensor 12, the position sensor 13, the traveling state sensor 14, and the input device 161 of the HMI 16 to the processor 33. In addition, the communication interface 31 transmits a signal output from the processor 33 to the output device 162 of the HMI 16 and to the vehicle actuator 21.

The storage unit 32 stores data. The storage unit 32 includes at least one of a volatile semiconductor memory, a nonvolatile semiconductor memory, a hard disk drive (HDD), and a solid state drive (SSD), for example. The storage unit 32 stores a program executed by the processor 33 of the ECU 30. Further, the storage unit 32 stores data transmitted from the vehicle exterior camera 11 or the like.

The processor 33 includes one or a plurality of central processing units (CPUs) and peripheral circuits thereof. The processor 33 may further include another arithmetic circuit such as a logical arithmetic unit or a numerical arithmetic unit. The processor 33 executes the computer program stored in the storage unit 32.

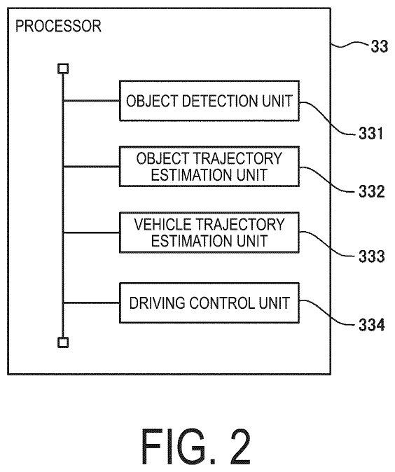

FIG. 2 is a functional block diagram of the processor 33 of the ECU 30. As illustrated in FIG. 2, the processor 33 includes an object detection unit 331, an object trajectory estimation unit 332, a vehicle trajectory estimation unit 333, and a driving control unit 334. These units included in the processor 33 are, for example, functional modules executed by the computer program operating on the processor 33. Alternatively, the units included in the processor 33 may be mounted to the ECU 30 as independent integrated circuits, microprocessors, or firmware.

The object detection unit 331 detects the object in front of the vehicle 100 based on the image data received from the vehicle exterior camera 11 and the distance measurement data received from the ranging sensor 12. For example, by sequentially inputting the image data to a discriminator, the object detection unit 331 detects a type of the object (for example, a pedestrian, a bicycle, a motorcycle, an automobile, a building, a plant, or the like) represented in an image of each of the image data, and a region in the image in which that object is represented. The discriminator is, for example, a convolutional neural network (CNN) having a plurality of convolutional layers connected in series from an input side to an output side. In addition, the object detection unit 331 detects the distance to each of the objects and the speed of each of the objects based on the region of the object represented in the image of each image data, and on the distance measurement data received from the ranging sensor 12. As a result, the object detection unit 331 detects the type of the object (for example, the pedestrian, the bicycle, the motorcycle, the automobile, the building, the plant, or the like) present in front of the vehicle 100, a relative position of the object with respect to the vehicle 100 (hereinafter, also simply referred to as a “relative position”), and a relative speed with respect to the vehicle 100 (hereinafter, also simply referred to as a “relative speed”). The detection of the object in front of the vehicle 100 is not limited to the above-described method, and may be performed by other known methods.

The object trajectory estimation unit 332 estimates a predicted movement trajectory, which is a trajectory along which the object detected by the object detection unit 331, that is, the object positioned in front of the vehicle 100, is predicted to move in the future. In the present embodiment, the predicted movement trajectory is a set of combinations of a future position of the object and of time. Therefore, the predicted movement trajectory includes not only a route along which the object is predicted to pass in the future but also a time at which the object is predicted to reach each of points of the route.

In the present embodiment, the object trajectory estimation unit 332 estimates the predicted movement trajectory of a movable specific object (for example, the pedestrian, the bicycle, the motorcycle, the automobile, or the like) among the objects detected by the object detection unit 331. In the present embodiment, the object trajectory estimation unit 332 estimates the predicted movement trajectory of the object based on the relative position and the relative speed of the specific object in front of the vehicle 100 detected by the object detection unit 331. For example, when the specific object detected by the object detection unit 331 is stationary, the object trajectory estimation unit 332 estimates that the object will remain at that position and thus the predicted movement trajectory is estimated to be one point at which the object is currently located. On the other hand, when the specific object detected by the object detection unit 331 is moving at a predetermined speed, the object trajectory estimation unit 332 estimates the predicted movement trajectory on the assumption that the object will continue to move at the current speed in the direction in which the object is currently moving. In particular, in the present embodiment, when the object located in front of the vehicle 100 is moving, the object trajectory estimation unit 332 estimates the predicted movement trajectory of that object. The object trajectory estimation unit 332 may estimate the predicted movement trajectory by a method different from the above-described method, as long as the predicted movement trajectory of the specific object detected by the object detection unit 331 can be estimated.

The vehicle trajectory estimation unit 333 estimates a scheduled movement trajectory that is a trajectory along which the vehicle 100 is scheduled to move in the future. In the present embodiment, the scheduled movement trajectory is a set of combinations of a future position of the vehicle 100 and of time. Therefore, the scheduled movement trajectory includes not only a route along which the vehicle 100 is scheduled to pass in the future but also a time at which the vehicle 100 is predicted to reach each of points of the route. Further, in the present embodiment, the vehicle trajectory estimation unit 333 estimates the scheduled movement trajectory of the vehicle 100 in a case where separation steering control (to be described later) is performed by the driving control unit 334 and the scheduled movement trajectory of the vehicle 100 in a case where the separation steering control is not performed.

When a specific object (for example, a pedestrian, a bicycle, a motorcycle, an automobile, or the like) is located in a region set in advance in front of the vehicle 100, the driving control unit 334 performs driving control of the vehicle 100 so as to reduce the possibility of collision with the object. More specifically, when the specific object is located in a steering operation region set in front of the vehicle 100, the driving control unit 334 executes separation steering control in which steering is performed so as to maintain a distance from the object. In addition, the driving control unit 334 executes deceleration control for decelerating the vehicle when the specific object is located in a deceleration operation region set in front of the vehicle 100.

### Basic Driving Control

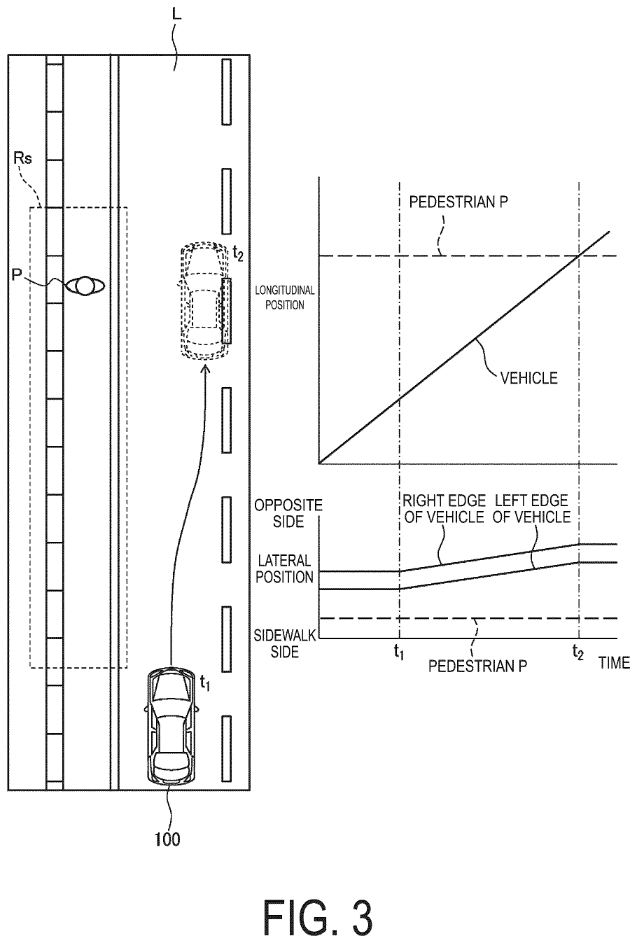

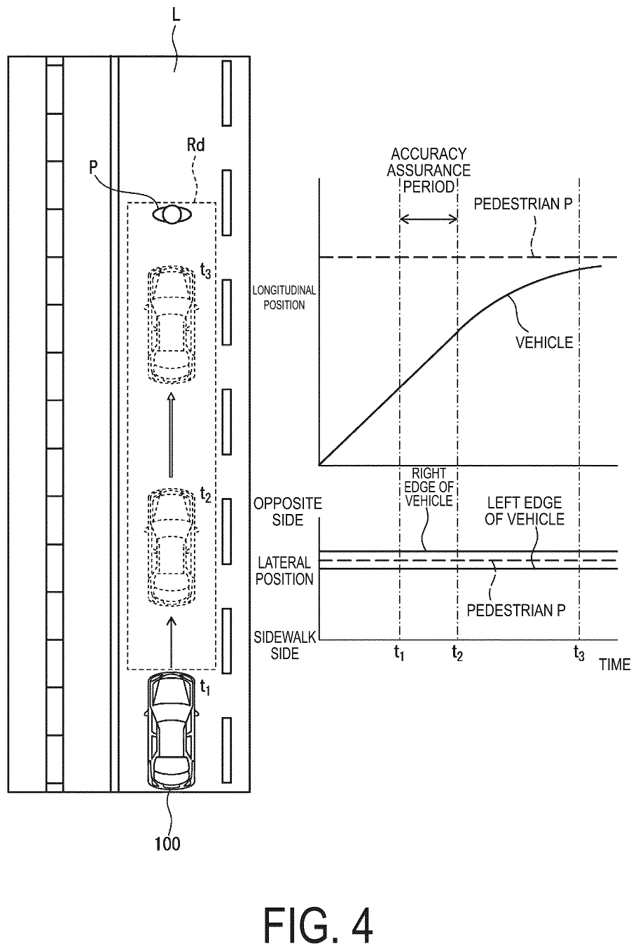

Next, the driving control by the driving control unit 334 will be described in more detail with reference to FIGS. 3 and 4.

First, the separation steering control will be described with reference to FIG. 3. FIG. 3 is a diagram schematically illustrating a state in which the separation steering control is performed. In particular, FIG. 3 illustrates a case in which a pedestrian P, who is the specific object, is present to the side in front of the vehicle 100. The left side of FIG. 3 is a diagram illustrating the movement of the vehicle 100 on the road, and the right side of FIG. 3 is a time chart of positions of the vehicle 100 and the pedestrian P in a longitudinal direction (a traveling direction of the vehicle 100) and a lateral direction (the direction perpendicular to the traveling direction of the vehicle 100).

As illustrated in FIG. 3, a steering operation region Rs is set in front of the vehicle 100. In the example illustrated in FIG. 3, in order to prevent complication of the drawing, the steering operation region Rs is set only on the left side of the vehicle 100, but the steering operation region Rs may also be set on the right side of the vehicle 100.

In the present embodiment, the steering operation region Rs is a region in front of and to the side of the vehicle 100, that is, a region in which any moving object jumping out in front of the vehicle 100 may be present. In the present embodiment, when the specific object, that is, the pedestrian P, the bicycle, the motorcycle, the automobile, or the like, is present in the steering operation region Rs, the separation steering control is executed in order to prevent a collision between the vehicle 100 and the specific object. In particular, in the separation steering control of the present embodiment, steering is performed, based on a current position of the object, so that the distance between the vehicle 100 and the object is maintained. Specifically, in the separation steering control, the steering is performed such that the vehicle 100 and the object are separated by a predetermined reference distance when the vehicle 100 passes by the object.

In the example illustrated in FIG. 3, when it is recognized at a time t₁ that the pedestrian P is located inside the steering operation region Rs, the separation steering control is executed from the time t₁ onward, in order to prevent a collision between the vehicle 100 and the pedestrian P. In the separation steering control, a steering operation is performed such that the vehicle 100 maintains a distance between the pedestrian P and the vehicle 100, that is, such that the vehicle 100 is separated from the pedestrian P in the lateral direction (vehicle width direction). As a result, the vehicle 100 moves in the lateral direction within a range in which the vehicle 100 does not move out of a vehicle lane, in a direction away from the pedestrian P (a direction toward an opposite vehicle lane). As a result, when the vehicle 100 passes by the pedestrian P at a time t₂, the vehicle 100 is separated from the pedestrian P in the lateral direction, and the collision between the vehicle 100 and the pedestrian P is suppressed.

In the example illustrated in FIG. 3, the entry of the pedestrian P into the steering operation region Rs is detected before the time t₁. Then, when the pedestrian P continues to be detected in the steering operation region Rs over a predetermined accuracy assurance period from when the pedestrian P has entered the steering operation region Rs, it is recognized that the pedestrian P is located in the steering operation region Rs. Here, as described above, the detection of the object such as the pedestrian P is performed based on the image data received from the vehicle exterior camera 11 and the distance measurement data received from the ranging sensor 12. However, since noise may be present in the image data and the distance measurement data, the type of the object, the distance, and the like may be erroneously detected. In the present embodiment, since the object is recognized only when the object is continuously detected over the accuracy assurance period, erroneous recognition of the object in the steering operation region Rs is suppressed.

Next, the deceleration control will be described with reference to FIG. 4. FIG. 4 is a diagram schematically illustrating a state in which the deceleration control is performed. In particular, FIG. 4 illustrates a case in which the pedestrian P, who is the specific object, is present centrally in front of the vehicle 100. The left side of FIG. 4 is a diagram illustrating the movement of the vehicle 100 on the road, and the right side of FIG. 4 is a time chart of positions of the vehicle 100 and the pedestrian P in the longitudinal direction (the traveling direction of the vehicle 100) and the lateral direction (the direction perpendicular to the traveling direction of the vehicle 100).

As illustrated in FIG. 4, a deceleration operation region Rd is set in front of the vehicle 100. In the present embodiment, the deceleration operation region Rd is a region in front of and at the center of the vehicle 100, that is, a region in which the object present in that region will come into contact with the vehicle 100 if the vehicle 100 continues on a present course. Therefore, in the present embodiment, the steering operation region Rs and the deceleration operation region Rd are different regions. The steering operation region Rs includes a region in front of and to the side of the vehicle 100, while the deceleration operation region Rd includes a region centrally in front of the vehicle 100. Further, in the present embodiment, the steering operation region Rs and the deceleration operation region Rd are regions that do not overlap each other, but may be regions that partially overlap each other. The steering operation region Rs and the deceleration operation region Rd may be the same region.

In the present embodiment, when it is recognized that the specific object, that is, the pedestrian, the bicycle, the motorcycle, the automobile, or the like is located in the deceleration operation region Rd, the deceleration control is executed in order to prevent a collision between the vehicle 100 and the specific object. In particular, in the present embodiment, the deceleration control is executed when it is continuously detected that the specific object is located in the deceleration operation region Rd for the predetermined accuracy assurance period. Therefore, even when the specific object is detected in the deceleration operation region Rd, the deceleration control is not executed unless the specific object is continuously detected over the accuracy assurance period.

In the example illustrated in FIG. 4, the presence of the pedestrian P in the deceleration operation region Rd is detected at the time t₁. Then, at the time t₂, the pedestrian P continues to be detected in the deceleration operation region Rd over the predetermined accuracy assurance period from the time t₁. It is thus recognized that the pedestrian P is located in the deceleration operation region Rd at the time t₂. When it is recognized that the pedestrian P is located in the deceleration operation region Rd at the time t₂, the deceleration control is executed from the time t₂ onward, in order to prevent a collision between the vehicle 100 and the pedestrian P. In the deceleration control, a deceleration operation is performed so that the vehicle 100 reaches the position of the pedestrian P more slowly. In the deceleration control, specifically, for example, a target speed is set to be lower as the distance between the vehicle 100 and the position of the pedestrian P becomes shorter, and the speed of the vehicle 100 is controlled to be the target speed. As a result, from the time t₂ onward, the speed of the vehicle 100 is gradually reduced, and the collision between the vehicle 100 and the pedestrian P is suppressed.

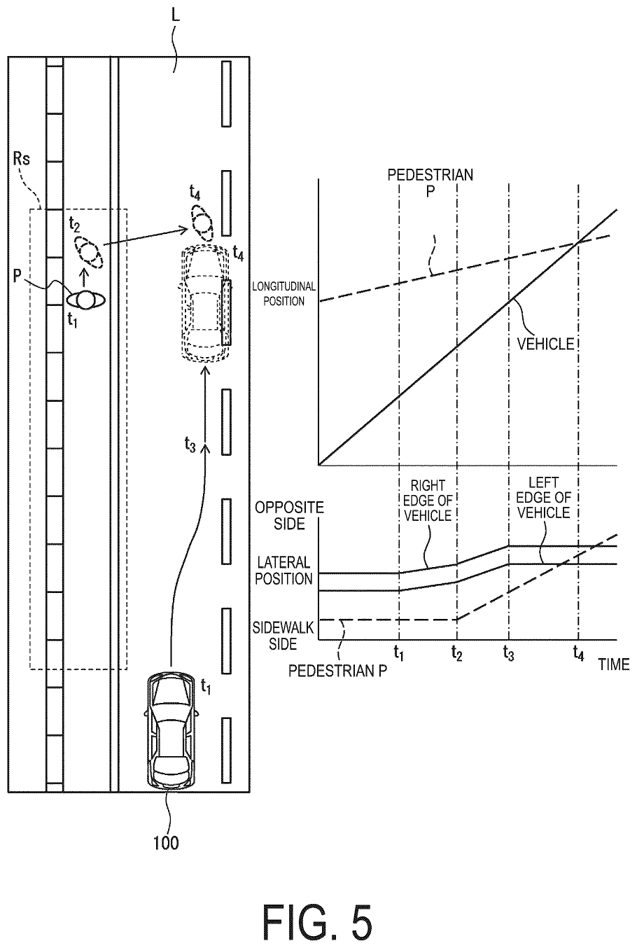

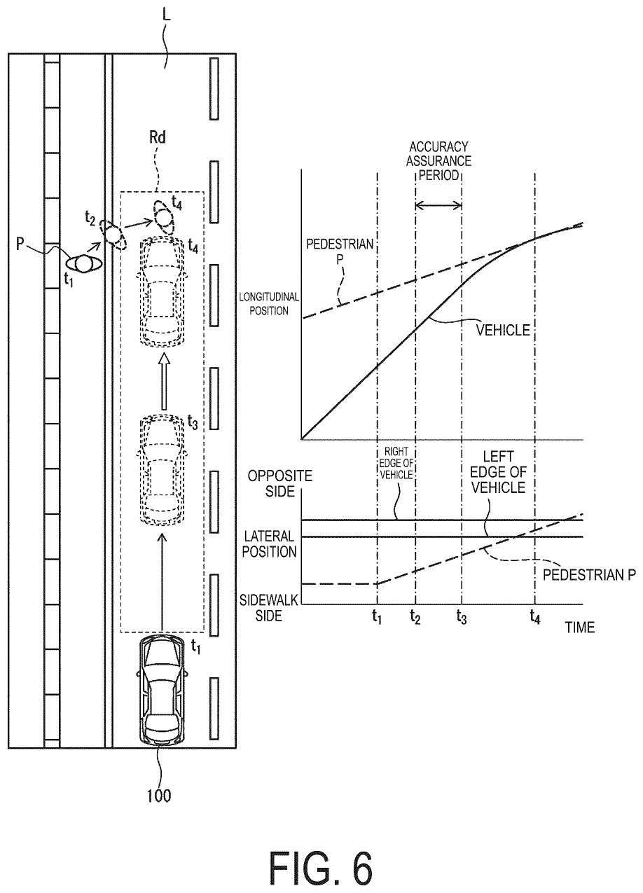

Next, problems when the separation steering control and the deceleration control as described above are performed will be described with reference to FIGS. 5 and 6.

First, a problem when the separation steering control is performed will be described with reference to FIG. 5. FIG. 5 is a view similar to FIG. 3, illustrating a state in which the separation steering control is performed. In the example illustrated in FIG. 5, in order to simplify the description, the deceleration of the vehicle 100 based on the deceleration control is not performed. In the example illustrated in FIG. 5, a state is illustrated in which, at the time t₂, the pedestrian P is about to enter a vehicle lane L in which the vehicle 100 is traveling (that is, enter the travel path of the vehicle 100).

In the example illustrated in FIG. 5, the presence of the pedestrian P in the steering operation region Rs is recognized at the time t₁, similarly to the example illustrated in FIG. 3. Therefore, the separation steering control is executed in the vehicle 100. In the example illustrated in FIG. 5, the pedestrian P is traveling in the same direction as the traveling direction of the vehicle 100 at the time t₁, and changes direction at the time t₂ to travel in a direction crossing the vehicle lane L. Here, as described above, in the separation steering control, the steering is performed based on the current position of the object so that the distance between the vehicle 100 and the object is maintained. Therefore, from the time t₂ onward, the steering is performed by the separation steering control so that the vehicle 100 moves away from the pedestrian P who is about to cross the vehicle lane L, that is, the vehicle 100 moves to the opposite vehicle lane side more quickly.

However, in the separation steering control, since the steering of the vehicle 100 is performed within a range in which the vehicle 100 does not move out of the vehicle lane L, when the vehicle 100 reaches an edge of the vehicle lane L in the lateral direction at a time t₃, the vehicle 100 does not move any further in the lateral direction (the direction toward the opposite vehicle lane side). As a result, in the example illustrated in FIG. 5, the pedestrian P and the vehicle 100 collide with each other at a time t₄.

Next, a problem when the deceleration control is performed will be described with reference to FIG. 6. FIG. 6 is a diagram similar to FIG. 4, illustrating a state in which the deceleration control is performed. In the example illustrated in FIG. 6, in order to simplify the description, the steering of the vehicle 100 based on the separation steering control is not performed. In particular, FIG. 6 illustrates a state in which the pedestrian P enters the vehicle lane L at the time t₂.

In the example illustrated in FIG. 6, at the time t₁, the pedestrian P is not located in the deceleration operation region Rd. Further, the pedestrian P travels in the traveling direction of the vehicle 100 and in a direction toward the inside of the vehicle lane L from the time t₁, and enters the deceleration operation region Rd at the time t₂. When the pedestrian P enters the deceleration operation region Rd at the time t₂, it is detected that the pedestrian P is located in the deceleration operation region Rd. Then, at the time t₃, the pedestrian P continues to be detected in the deceleration operation region Rd over the accuracy assurance period from time t₂, and it is thus recognized that the pedestrian P is located in the deceleration operation region Rd at the time t₃. Therefore, the deceleration control is executed from the time t₃ onward.

However, the vehicle 100 travels without executing the deceleration control during a period up until the accuracy assurance period elapses from the time t₂ at which the presence of the pedestrian P in the deceleration operation region Rd is initially detected. Thus, the vehicle 100 approaches the pedestrian P during the period from the time t₂ to the time t₃, and even if the deceleration control is started at the time t₃, the vehicle 100 may not be decelerated in time and may collide with the pedestrian P as illustrated in FIG. 6 (time t₄), or may be rapidly decelerated in the deceleration control.

### Control in Present Embodiment

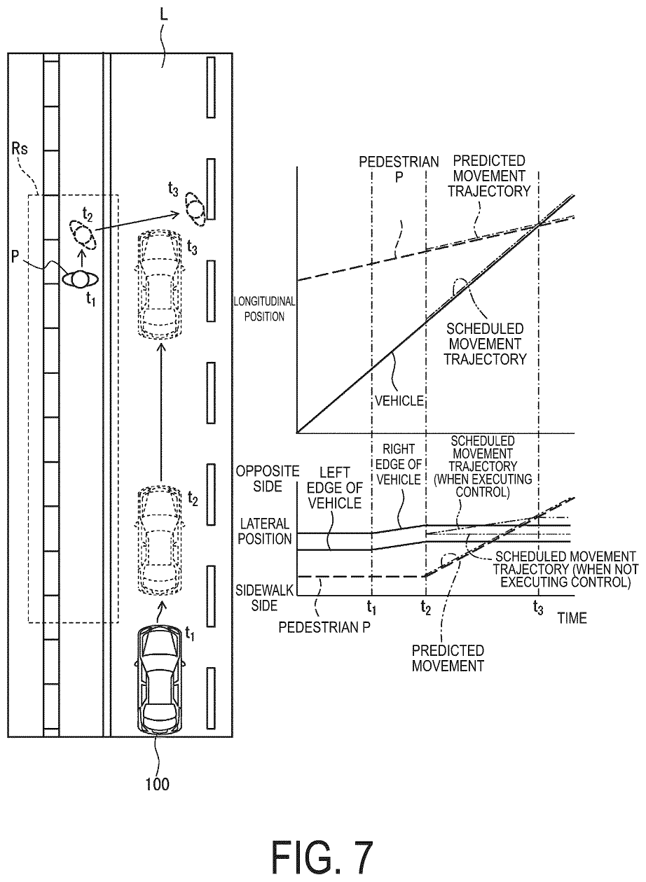

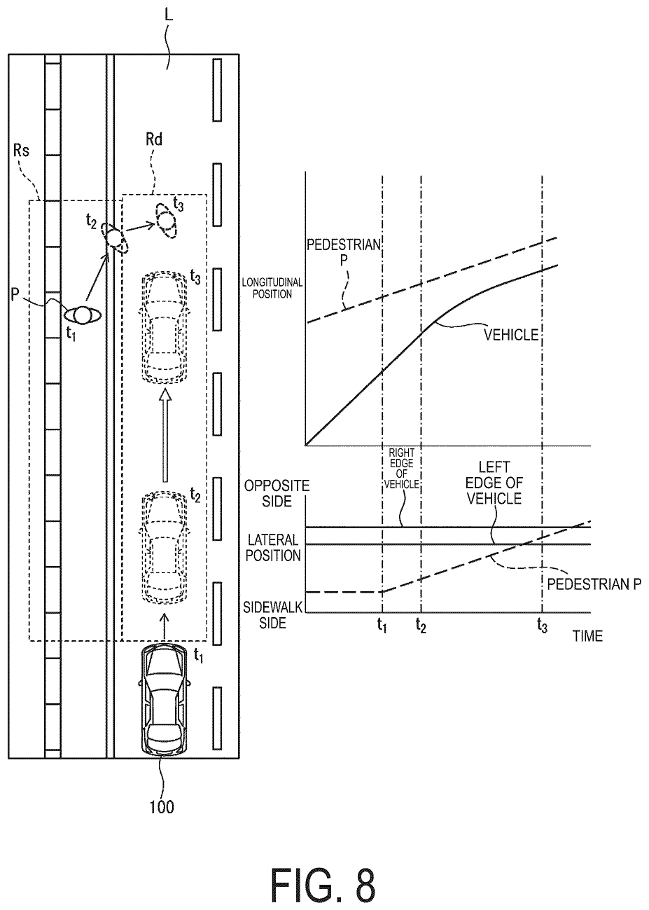

Here, in the present embodiment, in a case where the specific object is entering or is about to enter the travel path of the vehicle 100 during execution of the separation steering control, the driving control unit 334 changes an execution mode of the separation steering control or the deceleration control so that the risk of collision with the object is reduced, in contrast to any other case. A description will now be given of such a change in the execution mode, with reference to FIGS. 7 and 8.

FIG. 7 is a view similar to FIGS. 3 and 5, illustrating a state in which the separation steering control is performed. In the example illustrated in FIG. 7 also, in order to simplify the description, the deceleration of the vehicle 100 based on the deceleration control is not performed. The example illustrated in FIG. 7 also illustrates a state in which the pedestrian P is about to enter the vehicle lane L at the time t₂.

In the example illustrated in FIG. 7, similarly to the examples illustrated in FIGS. 3 and 5, the presence of the pedestrian P in the steering operation region Rs is recognized at the time t₁, and the separation steering control is executed. Then, in the example illustrated in FIG. 7, similarly to the example illustrated in FIG. 5, the pedestrian P changes direction at the time t₂ to travel in a direction crossing the vehicle lane L.

Here, in the present embodiment, the predicted movement trajectory of the object is estimated by the object trajectory estimation unit 332. In particular, in the example illustrated in FIG. 7, at the time t₂, the pedestrian P is traveling in the direction crossing the vehicle lane L. The object trajectory estimation unit 332 estimates the predicted movement trajectory of the pedestrian P based on the relative position and the relative speed of the pedestrian P at the time t₂. In the example illustrated in FIG. 7, the predicted movement trajectory of the pedestrian P at the time t₂ is estimated on the assumption that the pedestrian P will move in the movement direction of the pedestrian P at the time t₂ at the movement speed of the pedestrian P at the time t₂.

In addition, in the present embodiment, the vehicle trajectory estimation unit 333 estimates the scheduled movement trajectory of the vehicle 100 in the case where the separation steering control is executed and the scheduled movement trajectory of the vehicle 100 in the case where the separation steering control is not executed. In the example illustrated in FIG. 7, at the time t₂, the scheduled movement trajectory of the vehicle 100 is estimated. In particular, in the present embodiment, the scheduled movement trajectory of the vehicle 100 in the case where the separation steering control is executed is estimated on the assumption that the pedestrian P remains at the position of the time t₂ even after the time t₂. Note that the scheduled movement trajectory of the vehicle 100 when the separation steering control is executed may be estimated on the assumption that the pedestrian P moves along the predicted movement trajectory.

In the present embodiment, the scheduled movement trajectory of the vehicle 100 when the separation steering control is not executed is estimated on the assumption that the position of the vehicle 100 in the lateral direction in the vehicle lane does not change after the time t₂. Therefore, for example, when the vehicle 100 is traveling on a straight road, the scheduled movement trajectory of the vehicle 100 in the case where the separation steering control is not executed is estimated on the assumption that the vehicle 100 travels in a straight line. On the other hand, when the vehicle 100 is traveling on a curve, the scheduled movement trajectory of the vehicle 100 in the case where the separation steering control is not executed is estimated on the assumption that the vehicle 100 is traveling in a curve in accordance with the curvature of the curve. Note that, the scheduled movement trajectory of the vehicle 100 when the separation steering control is not executed may be estimated based on the assumption that normal steering control is performed, in a case where the normal steering control is performed that is different from the separation steering control when the separation steering control is not performed.

Then, in the present embodiment, the driving control unit 334 calculates a shortest distance Ds between the object passing along the predicted movement trajectory and the vehicle 100 passing along the scheduled movement trajectory in the case where the separation steering control is executed (hereinafter, also referred to as the “shortest distance when the separation steering control is being executed”). In addition, the driving control unit 334 calculates a shortest distance Dn between the object passing along the predicted movement trajectory and the vehicle 100 passing along the scheduled movement trajectory in the case where the separation steering control is not executed (hereinafter, also referred to as the “shortest distance when the separation steering control is not being executed”). Then, when the shortest distance Ds when the separation steering control is being executed is longer than the shortest distance Dn when the separation steering control is not being executed, the driving control unit 334 continues to execute the separation steering control. On the other hand, when the shortest distance Ds when the separation steering control is being executed is shorter than the shortest distance Dn when the separation steering control is not being executed, the driving control unit 334 stops the separation steering control and does not execute the separation steering control. In the example illustrated in FIG. 7, the shortest distance Ds when the separation steering control is being executed is shorter than the shortest distance Dn when the separation steering control is not being executed. Therefore, the separation steering control is not executed after the time t₂.

Further, in the example illustrated in FIG. 7, the pedestrian P is positioned outside the vehicle lane L and in the steering operation region Rs and is about to enter the vehicle lane L (time t₂), and is predicted to interfer with the vehicle 100 when the vehicle 100 is controlled by the separation steering control. In such a case, the driving control unit 334 does not execute the separation steering control. Similarly, when the pedestrian P is positioned in the vehicle lane L and in the steering operation region Rs, is about to cross the vehicle lane L, and is predicted to interfere with the vehicle 100 when the vehicle 100 is controlled by the separation steering control, the driving control unit 334 may not execute the separation steering control. Thus, in a case where the object is entering or is about to enter the travel path of the vehicle 100 when the separation steering control is being executed, and is predicted to interfere with the vehicle 100 when the vehicle 100 is controlled by the separation steering control, the driving control unit 334 does not execute the separation steering control. By such control being performed by the driving control unit 334, the possibility of the collision between the vehicle 100 and the specific object (such as the pedestrian) entering or about to enter the travel path of the vehicle 100 is reduced.

FIG. 8 is a view similar to FIG. 4, illustrating a state when the deceleration control is performed. In the example illustrated in FIG. 8, when the specific object has entered the travel path of the vehicle 100 when the separation steering control is being executed, the execution mode of the deceleration control is changed. Note that, in the example illustrated in FIG. 8 also, in order to simplify the description, the steering of the vehicle 100 based on the separation steering control is not performed.

In the example illustrated in FIG. 8, similarly to the example illustrated in FIG. 6, the pedestrian P travels in the traveling direction of the vehicle 100 and in a direction toward the inside of the vehicle lane L from the time t₁, and enters the deceleration operation region Rd at the time t₂. In the example illustrated in FIG. 8, from before the time t₁, it is recognized that the pedestrian P is located in the steering operation region Rs, and the separation steering control is being executed (however, in order to simplify the description, the movement of the vehicle 100 in the lateral direction as a result of the separation steering control is not illustrated). Then, in the example illustrated in FIG. 8, the pedestrian P enters the deceleration operation region Rd at the time t₂, similarly to the example illustrated in FIG. 6. When the pedestrian P enters the deceleration operation region Rd at the time t₂, it is detected that the pedestrian P is located in the deceleration operation region Rd.

Here, in the present embodiment, when the separation steering control is being executed, the driving control unit 334 executes the deceleration control as soon as it is detected that the specific object is located in the deceleration operation region Rd. In particular, in the present embodiment, in the case where the separation steering control is being executed, the driving control unit 334 executes the deceleration control as soon as the object recognized to be located in the steering operation region Rs is recognized to be located in the deceleration operation region Rd.

In the example illustrated in FIG. 8, in the state in which the separation steering control is being executed, the pedestrian P recognized to be located in the steering operation region Rs enters the deceleration operation region Rd at the time t₂. Thus, when it is detected that the pedestrian P is located in the deceleration operation region Rd, the driving control unit 334 immediately starts the deceleration control, without waiting for the accuracy assurance period to elapse. In the deceleration control, the deceleration operation is performed so that the vehicle 100 reaches the current position of the pedestrian P more slowly.

On the other hand, in the present embodiment, in a case where the separation steering control is not being executed, even if it is detected that the specific object is positioned in the deceleration operation region Rd, the deceleration control is executed after the accuracy assurance period elapses. Therefore, in such a case, even if it is detected that the specific object is located in the deceleration operation region Rd, the deceleration control is not immediately executed. Thus, in the present embodiment, the start timing of the deceleration control is made earlier when the specific object enters the travel path of the vehicle 100 when the separation steering control is being executed than when the specific object enters the travel path of the vehicle 100 when the separation steering control is not being executed.

In addition, even when the separation steering control is being executed, when the specific object that is different from the object recognized as being located in the steering operation region Rs is detected as being located in the deceleration operation region Rd, the deceleration control may be executed when the specific object is continuously recognized as being located in the deceleration operation region Rd over the accuracy assurance period (when the specific object is recognized as being located in the deceleration operation region Rd). Thus, in such a case also, even when it is detected that the specific object is located in the deceleration operation region Rd, the deceleration control is not immediately executed.

In the present embodiment, when the separation steering control is being executed, the deceleration control is executed as soon as it is detected that the specific object (such as the pedestrian) is located in the deceleration operation region Rd. Thus, according to the present embodiment, the possibility of the collision between the specific object (such as the pedestrian) and the vehicle 100 is reduced, compared with a case where the deceleration control is started after waiting for the accuracy assurance period to elapse. In particular, when the separation steering control is being executed, since it has been detected that the specific object is located within the steering operation region Rs over the accuracy assurance period at the time of starting the separation steering control, there is a low possibility that the specific object is being erroneously detected. In particular, when the object recognized to be located in the steering operation region Rs is detected to be located in the deceleration operation region Rd, there is a low possibility that the specific object is being erroneously detected. Therefore, in the present embodiment, while reducing the possibility that the specific object is being erroneously detected, the possibility of the collision between the specific object and the vehicle 100 is reduced.

As described above, in the present embodiment, in the case where the specific object is entering or is about to enter the travel path of the vehicle 100 (the vehicle lane in a case where there is a vehicle lane demarcated by a demarcation line) during the execution of the separation steering control, and is predicted to interfere with the vehicle 100 when the vehicle 100 is controlled by the separation steering control, the driving control unit 334 does not execute the separation steering control. In addition, in the case where the specific object enters the travel path of the vehicle 100 when the separation steering control is being executed, the driving control unit 334 sets the start timing of the deceleration control earlier than in the case where the specific object enters the travel path of the vehicle 100 when the separation steering control is not being executed. Therefore, in the present embodiment, in a case where the specific object is entering or is about to enter the travel path of the vehicle 100 during execution of the separation steering control, the driving control unit 334 changes the execution mode of the separation steering control or the deceleration control such that the risk of the collision with the specific object is reduced, in contrast to any other case. Accordingly, the possibility of the collision between the specific object and the vehicle 100 is reduced.

### Specific Example of Control

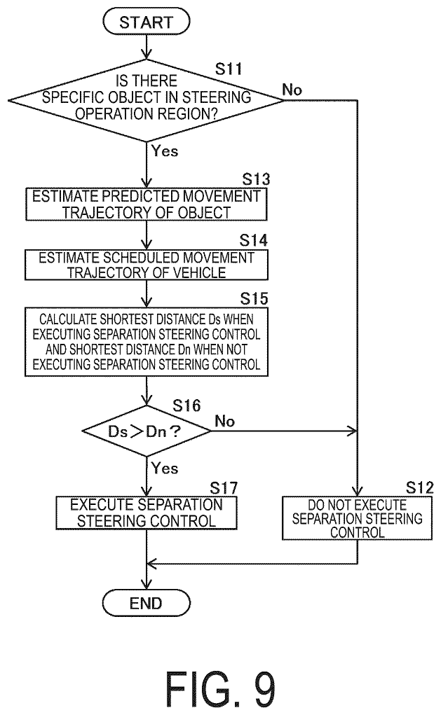

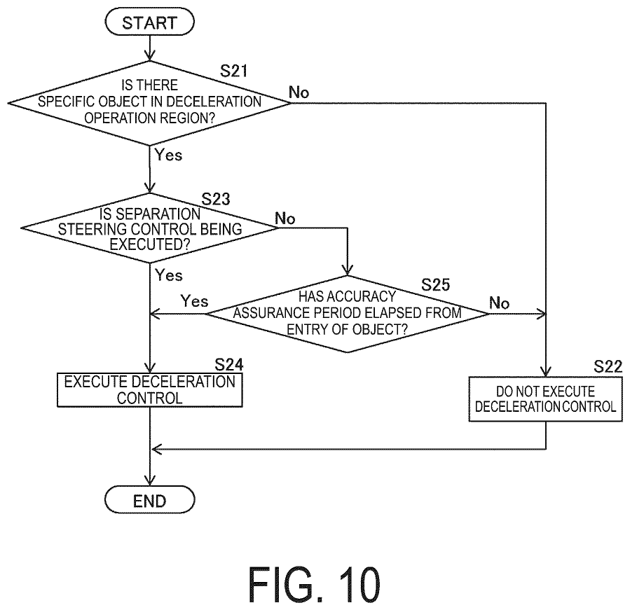

Next, a specific example of the control will be described with reference to FIGS. 9 and 10. FIG. 9 is a flowchart illustrating a flow of separation steering processing to determine whether or not execution of the separation steering control is necessary. The separation steering processing is executed at a constant time interval by the driving control unit 334 of the processor 33.

When the separation steering processing is executed, as illustrated in FIG. 9, first, the driving control unit 334 determines whether or not the specific object is located in the steering operation region Rs (step S11). Specifically, the driving control unit 334 determines whether or not the object detected by the object detection unit 331 is the specific object (for example, the pedestrian, the bicycle, the motorcycle, the automobile, or the like). In addition, when the detected object is the specific object, the driving control unit 334 determines whether or not the specific object is located in the steering operation region Rs.

When it is determined at step S11 that the specific object is not located in the steering operation region Rs, the driving control unit 334 does not execute the separation steering control (step S12). Thus, the steering of the vehicle 100 is manually operated by the driver. Alternatively, when the steering control of the vehicle 100 is automatically performed, the normal steering control that is not the separation steering control is performed. In the normal steering control, the driving control unit 334 performs the steering such that the vehicle 100 travels through the center of the vehicle lane L based on, for example, the outputs of the vehicle exterior camera 11, the ranging sensor 12, the position sensor 13, and the traveling state sensor 14.

When it is determined at step S11 that the specific object is located in the steering operation region Rs, the object trajectory estimation unit 332 estimates the predicted movement trajectory of the specific object (step S13). Next, the vehicle trajectory estimation unit 333 estimates the scheduled movement trajectory of the vehicle 100 (step S14). At this time, the vehicle trajectory estimation unit 333 estimates the scheduled movement trajectory of the vehicle 100 in the case where the separation steering control is performed and the scheduled movement trajectory of the vehicle 100 in the case where the separation steering control is not performed.

Next, based on the predicted movement trajectory estimated at step S13 and the scheduled movement trajectory estimated at step S14, the driving control unit 334 calculates the shortest distance Ds when the separation steering control is being executed and the shortest distance Dn when the separation steering control is not being executed (step S15).

Thereafter, the driving control unit 334 determines whether or not the shortest distance Ds when the separation steering control is being executed is longer than the shortest distance Dn when the separation steering control is not being executed (step S16). When it is determined at step S16 that the shortest distance Ds when the separation steering control is being executed is equal to or less than the shortest distance Dn when the separation steering control is not being executed, the driving control unit 334 does not execute the separation steering control (step S12). On the other hand, when it is determined at step S16 that the shortest distance Ds when the separation steering control is being executed is longer than the shortest distance Dn when the separation steering control is not being executed, the driving control unit 334 executes the separation steering control (step S17).

FIG. 10 is a flowchart illustrating a flow of deceleration processing to determine whether or not execution of the deceleration control is necessary. The deceleration processing is executed at a constant time interval by the processor 33 of the ECU 30.

When the deceleration processing is executed, as illustrated in FIG. 10, first, the driving control unit 334 determines whether or not the specific object is located in the deceleration operation region Rd (step S21). Specifically, the driving control unit 334 determines whether or not the object detected by the object detection unit 331 is the specific object (for example, the pedestrian, the bicycle, the motorcycle, the automobile, or the like). In addition, when the detected object is the specific object, the driving control unit 334 determines whether or not the specific object is located in the deceleration operation region Rd.

When it is determined at step S21 that the specific object is not located in the deceleration operation region Rd, the driving control unit 334 does not execute the deceleration control (step S22). Thus, acceleration and deceleration of the vehicle 100 is manually controlled by the driver. Alternatively, when the acceleration/deceleration of the vehicle 100 is automatically performed, normal acceleration/deceleration control, which is not the deceleration control, is performed based on the outputs of the vehicle exterior camera 11, the ranging sensor 12, the position sensor 13, and the traveling state sensor 14. In the normal acceleration/deceleration control, for example, when another vehicle is traveling in front of the vehicle 100, the driving control unit 334 performs acceleration and deceleration so that a distance to the other vehicle is a predetermined constant distance. In addition, for example, when the other vehicle is not traveling in front of the vehicle 100, the driving control unit 334 performs acceleration and deceleration so that the vehicle 100 travels at a predetermined constant speed.

When it is determined at step S21 that the specific object is located in the deceleration operation region Rd, the driving control unit 334 determines whether or not the separation steering control is being executed from before the object is located in the deceleration operation region Rd (step S23). When it is determined at step S23 that the separation steering control is being executed, the driving control unit 334 executes the deceleration control (step S24). On the other hand, when it is determined at step S23 that the separation steering control is not being executed, the driving control unit 334 determines whether or not the predetermined accuracy assurance period has elapsed from when the specific object enters the deceleration operation region Rd (step S25). When it is determined at step S25 that the predetermined accuracy assurance period has elapsed, the driving control unit 334 executes the deceleration control (step S24). On the other hand, when it is determined at step S25 that the predetermined accuracy assurance period has not elapsed, the driving control unit 334 does not execute the deceleration control (step S22).

Although the preferred embodiments according to the present disclosure have been described above, the present disclosure is not limited to these embodiments, and various modifications and changes can be made within the scope of the claims. Further, a computer program product including the computer program according to the above-described embodiment may be stored in a storage medium or distributed through a communication line.

1. A driving control device that controls driving of a vehicle, the driving control device comprising a processor, the processor is configured to:
when a specific object is located in a steering operation region set in front of the vehicle, execute separation steering control of performing steering to maintain a distance between the vehicle and the object, and when the specific object is located in a deceleration operation region set in front of the vehicle, execute deceleration control of decelerating the vehicle, and
in a case where an object is entering or is about to enter a travel path of the vehicle during the execution of the separation steering control, change an execution mode of the separation steering control or the deceleration control to cause a collision risk with the object to be reduced, compared to any other case.

2. The driving control device according to claim 1, wherein
the processor is configured to:
in the separation steering control, perform steering to maintain the distance between the vehicle and the object based on a current position of the object, and
in a case where the object is entering or is about to enter the travel path of the vehicle during the execution of the separation steering control and it is predicted that the object will interfere with the vehicle when the vehicle is controlled by the separation steering control, not execute the separation steering control.

3. The driving control device according to claim 1, wherein
the processor is configured to:
estimate a predicted movement trajectory of the object;
estimate a scheduled movement trajectory of the vehicle in a case where the separation steering control is executed and in a case where the separation steering control is not executed; and
not execute the separation steering control, in a case where the object is entering or is about to enter the travel path of the vehicle during the execution of the separation steering control and a shortest distance between the object passing along the predicted movement trajectory and the vehicle passing along the scheduled movement trajectory in a case where the separation steering control is executed is shorter than a shortest distance between the object passing along the predicted movement trajectory and the vehicle passing along the scheduled movement trajectory in a case where the separation steering control is not executed.

4. The driving control device according to claim 3, wherein
the processor is configured to execute the separation steering control, in a case where the object is entering or is about to enter the travel path of the vehicle during the execution of the separation steering control and the shortest distance between the object passing along the predicted movement trajectory and the vehicle passing along the scheduled movement trajectory in a case where the separation steering control is executed is longer than the shortest distance between the object passing along the predicted movement trajectory and the vehicle passing along the scheduled movement trajectory in a case where the separation steering control is not executed.

5. The driving control device according to claim 1, wherein
the processor is configured to, in a case where the object enters into the travel path of the vehicle during the execution of the separation steering control, cause a start timing of the deceleration control to be earlier, compared to a case where the object enters into the travel path of the vehicle when the separation steering control is not being executed.

6. The driving control device according to claim 5, wherein
the processor is configured to:
detect an object in front of the vehicle;
in a case where the separation steering control is not being executed, execute the deceleration control when it is continuously detected, over a certain period of time, that the object is located in the deceleration operation region, and not execute the deceleration control before the certain time period elapses; and
in a case where the separation steering control is being executed, execute the deceleration control as soon as it is detected that the object is located in the deceleration operation region.

7. The driving control device according to claim 6, wherein
the processor is configured to:
in a case where the separation steering control is being executed, execute the deceleration control as soon as it is detected that an object recognized as being located in the steering operation region different from the deceleration operation region is located in the deceleration operation region; and
in a case where, even when the separation steering control is being executed, it is detected that an object different from the object recognized as being located in the steering operation region is located in the deceleration operation region, execute the deceleration control when it is continuously detected, over a certain period of time, that the object is located in the deceleration operation region.

8. The driving control device according to claim 1, wherein
the steering operation region and the deceleration operation region are different regions,
the steering operation region includes a region in front of and to the side of the vehicle, and
the deceleration operation region includes a region centrally in front of the vehicle.

9. A driving control method of controlling driving of a vehicle, the method comprising:
when a specific object is located in a steering operation region set in front of the vehicle, executing separation steering control of performing steering to maintain a distance between the vehicle and the object, and, when the specific object is located in a deceleration operation region set in front of the vehicle, executing deceleration control of decelerating the vehicle; and
in a case where an object is entering or is about to enter a travel path of the vehicle during execution of the separation steering control, changing an execution mode of the separation steering control or the deceleration control to cause a collision risk with the object to be reduced, compared to any other case.

10. A non-transitory readable medium having recorded thereon a driving control program of controlling driving of a vehicle, the driving control program causing a computer to execute processes comprising:
when a specific object is located in a steering operation region set in front of the vehicle, executing separation steering control of performing steering to maintain a distance between the vehicle and the object, and, when the specific object is located in a deceleration operation region set in front of the vehicle, executing deceleration control of decelerating the vehicle; and
in a case where an object is entering or is about to enter a travel path of the vehicle during execution of the separation steering control, changing an execution mode of the separation steering control or the deceleration control to cause a collision risk with the object to be reduced, compared to any other case.
